(19) United States
(12) Patent Application Publication
(10) Pub. No.: US 2007/0250512 A1
(43) Pub. Date: Oct. 25, 2007

(54) Video interactivity via connectivity through a conditional access system

(75) Inventors: Jeremy N. Friedlander, Austin, TX (US); Shree A. Dandekar, Round Rock, TX (US); David Konetski, Austin, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 11/410,125

(22) Filed: Apr. 24, 2006

(51) Int. Cl. G06F 17/30

(52) U.S. Cl. 707/10

(57) ABSTRACT

Methods and systems for accessing DVD off-disc content using a broadband conditional access network are described. In one embodiment, content is read from optical media and based on that content, a request is initiated to a conditional access network interface for content not stored on the optical media. Content is supplied in response to the request and received from the conditional access network interface. Graphical display signals are generated for a user display based on the content supplied in response to the request.

### BACKGROUND

The present disclosure relates to information handling systems, and more particularly to methods and systems for providing off-disc content for devices such as optical disc players when a traditional broadband data network is unavailable but a conditional access system is available.

As the value and use of information continues to increase, individuals and businesses seek additional ways to acquire, process and store information. One option available to users is information handling systems. An information handling system (“IHS”) generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, entertainment, and/or global communications. In addition, IHSs may include a variety of hardware and software components that may be configured to process, store, and communicate information and may include one or more computer systems, data storage systems, and networking systems.

Digital content distribution media such as digital video discs (DVDs) typically include a menu enabling users to perform various functions such as playing a movie, setting up audio/video options, selecting scenes, selecting sub-titles, etc. Some DVDs contain additional media content such as deleted scenes, commentaries, trailers of upcoming attractions, and similar features. Some of the more recent DVDs, particularly including next-generation optical media such as Blu-Ray and HD-DVD, can include interactive media content that, when selected, attempts to access, e.g., a studio website, to provide additional off-disc content to the user. For example, the application providing the interactive media content may offer the user the opportunity to: view trailers for upcoming (at the time of viewing instead of at the time of DVD release) movies that viewers of the current DVD would likely be interested; access a website dedicated to the movie; view additional background information, not included on the DVD, on the movie or its actors; shop for licensed products or offers related to the movie; and download and play games based on the movie's plotline or characters. The off-DVD content may help sell the DVD, or related products/services, due at least in part to its ability to offer content that is up to date at the time of viewing, content tailored to the viewer and available at the time and place of DVD viewing, and/or content available only to those in possession of the DVD.

### SUMMARY

According to one embodiment, a method for delivering media content to a user is described. Based on content read from optical media, a request is initiated to a conditional access network interface for content not stored on the optical media. Content supplied in response to the request is received from the conditional access network interface. Graphical display signals for a user display are generated, based on the content supplied in response to the request.

### BRIEF DESCRIPTION OF THE DRAWINGS

FIG. 1 illustrates a system for providing optical media off-disc content according to an embodiment.

FIG. 2 contains illustrating operation of a content server according to an embodiment.

FIG. 3 contains a block diagram for a set top box embodiment.

FIG. 4 contains a flow chart for operation of the FIG. 3 embodiment.

FIG. 5 contains a block diagram for an embodiment containing an optical disc player communicating with a set top box.

FIG. 6 contains a flow chart for operation of the FIG. 5 embodiment.

FIG. 7 illustrates a general block diagram for an IHS useful with embodiments.

### DETAILED DESCRIPTION

At least some viewers appreciate enhanced DVD content offered via network connectivity (“off-disc content”), as may be advertised on the DVD packaging and/or apparently accessible through the DVD menus. Among these viewers that would be interested in the off-disc content, many have no broadband Internet connection at all, or at least no broadband Internet connection accessible near the IHS that is playing the DVD. These viewers will have a less-than-satisfying viewing experience when they discover that they cannot access these enhanced off-DVD features because their DVD-playing IHS has no broadband Internet connection.

Among the universe of viewers who have no broadband Internet connection at their DVD player, many will have the DVD player located near a broadband connection to a conditional access network that delivers digital cable television signals or digital satellite television signals to a set-top box. The set-top box typically must contain a valid Access Card to access the content offered by the cable/satellite provider. The Access Card allows the user to receive channels in a purchased “package” and pay-per-view (PPV) video-on-demand movies ordered by the subscriber.

Although other services and channels may exist on the cable/satellite downlink, the set-top box hardware/software only allows the subscriber to access content purchased by the subscriber. In a digital cable system, the set-top box typically is allowed to communicate PPV orders and other viewing information directly over the cable to the system operator, using a proprietary data format. In a satellite system, the set-top box typically is equipped with a telephone modem, and uses an analog phone connection to communicate PPV orders and other viewing information at low bit rates to the satellite provider.

Two-way satellite systems and fiber optic systems are examples of other potentially competing conditional access network configurations. As the broadband delivery method of the conditional access network is not critical, the remaining discussion will focus on a cable television (CATV) system. Those skilled in the art will recognize that the CATV examples are readily transferable to competing conditional access network delivery technologies.

In the embodiments described below, a DVD-playing IHS accesses off-DVD content via the CATV operator's conditional access network. For instance, in one embodiment the CATV operator provisions a server to handle requests generated by subscribers for off-DVD content. The DVD-playing IHS and/or a connected CATV set top box recognizes the capability for content requests to be handled by a conditional access network content server. When the DVD media links to off-disc content, one or more content requests are formatted for transmission to the CATV operator's content server. These requests are transmitted, e.g., over the proprietary format service used to order video-on-demand services and up/download set top box data/software, to an uplink receiver coupled to the content server.

When the content server receives a DVD off-disc content request, it fills the request by connecting to a studio content server, accessing locally cached copies of the requested content, and/or offering content customized for the particular DVD disc and offered through the CATV operator's video on demand service. The retrieved content is downloaded to the subscriber, e.g., using a video-on-demand broadband channel.

When implemented as described above, such a service can offer significant advantages to a cable/satellite subscriber. The subscriber can leverage the video download bandwidth existing in their cable/satellite system to access DVD off-disc content and additional offerings. For users that have no separate broadband Internet connection, no broadband Internet connection with easy access near their media viewing system, or have some aversion to computer network setup and maintenance, the off-disc content service offers access to DVD extended features that would be otherwise inaccessible. With an appropriate system design, the service can offer plug-and-play operation with little or no user setup, with the fact that some content is located off-disc being transparent, or nearly so, to the subscriber.

The cable/satellite operator can also benefit from offering the off-DVD content service over a conditional access network. The operator may learn subscriber preferences that allow it to cross-sell its subscribers with video-on-demand, expanded content, premium channels, and other products that would be particularly enticing to the subscriber at the time a DVD is viewed. As DVD off-disc capabilities expand, the off-DVD content service may be attractive enough that subscribers will pay for the service to be delivered by the cable/satellite operator, or that the service may be a significant market differentiator for those operators offering the technology. Studios may also pay to have certain services delivered to a finely targeted audience—services such as trailers for upcoming new releases that are typically of interest to viewers of the current DVD due to a common genre, age group appeal, common actors or director, etc.

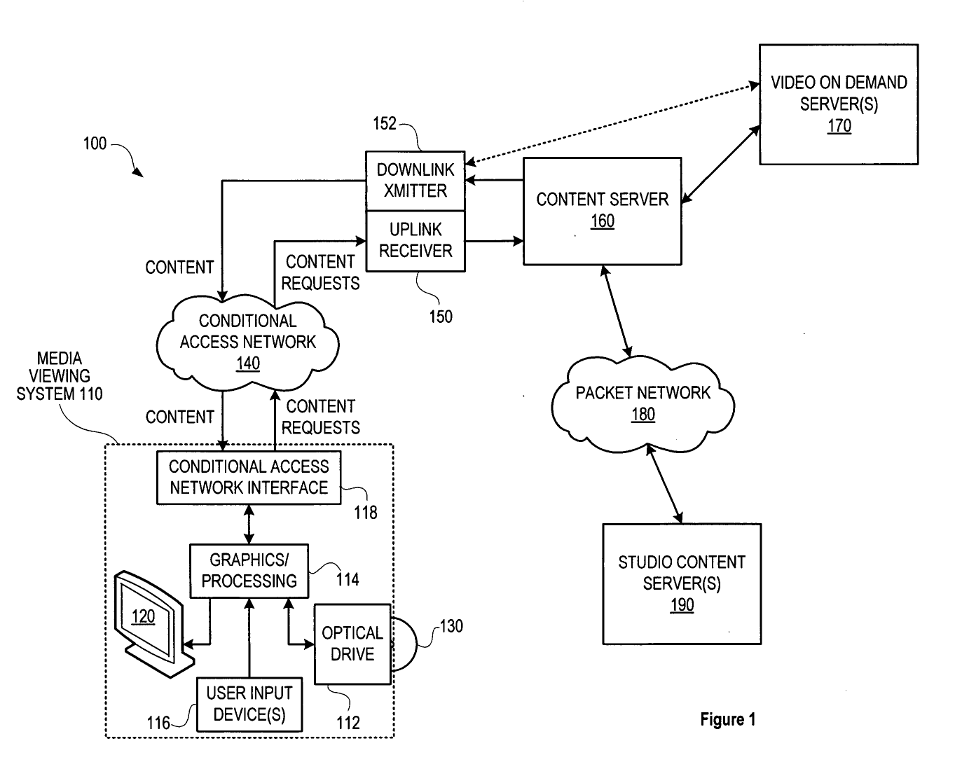

Referring now to FIG. 1, a first overall system embodiment 100 is illustrated. A media viewing system 110 includes one or more IHSs, with components including an optical drive 112, graphics/processing 114, user input devices 116, a conditional access network interface 118, and a display 120. A cable/satellite operator system includes an uplink receiver 150, a downlink transmitter 152, a content server 160, and at least in this embodiment one or more video on demand servers 170 and a connection to a packet network 180. A conditional access network 140, offering broadband downlink capability and owned/leased by the cable/satellite operator, connects the subscriber's media viewing system to the operator's server systems. Finally, DVDs 130 readable by the optical drive 112 contain links to off-disc content located, e.g., at studio content servers 190 connected to packet network 180.

Media viewing system 110 operates as follows. Graphics/processing 114 contains one or more processors, and operates according to computer instructions embodied in firmware, software, scripts, mark-up languages, etc., and digital graphics/audio data, in order to generate video (and audio) signals for a display 120 and audio system (not shown). The computer instructions typically originate from an optical disc 130, content/software provided over the conditional access network 140, and content previously stored in system 110 in read-only memory, flash memory, dynamic random access memory, a magnetic disk drive, etc. (not shown).

Depending on how the system is configured, the user manipulates one or more suitable user input devices 116 to cause graphics/processing 114 to execute selected sets of computer instructions. For instance, with a remote control as an input device, the user can play, pause, fast-forward, rewind, skip scenes, access menus, setup playback options such as language, and navigate the menus found on DVD 130. Graphics/processing 114 interprets the user's selections to control optical drive 112, generate video and audio in accordance with the user's expectations, and provide visual feedback when the user is navigating on-screen selection menus.

Certain DVD features and content selections may refer (with or without the user's knowledge) to content that is not actually imprinted on the optical disc, but is instead stored on an Internet-accessible server. Such Internet-accessible content is provided, e.g., by way of DVD content-embedded links to Internet-accessible sites and files served at those sites.

Media viewing system 110 may have an unrestricted broadband network connection (or at least a port for such a connection, not shown) and software to communicate across (for instance) a TCP/IP/Ethernet connection with remote hosts such as studio content servers 190. In the present embodiment if such a connection exists it is not currently in use.

Instead, graphics/processing 114 operates a communication protocol to encapsulate requests for off-disc content into packets addressed to content server 160. The particulars of the encapsulation format and any expected link, network, and transmission control protocols generally are specific to the system operator and the format the operator expects for transmissions sent from a subscriber up to the operator's system. In particular, the encapsulation format can flag each packet derived from DVD content as based on an optical media request, indicate the specific optical media from which the request was derived, and imbed the “native Internet” request for parsing and interpretation by the content server 160.

The encapsulated packets are supplied to the conditional access network interface 118. The network interface provides physical layer services to transmit the content requests, and may also provide conditional access network link, network, and transport layer services for the media viewing system. Likewise, when the content server returns the requested content, the conditional access network interface recognizes the content as related to the DVD off-disc protocol, and delivers the content to a driver running on graphics/processing 114 for the DVD off-disc protocol. Finally, the off-disc content is processed by graphics/processing 114 for integration into the graphics generated, as appropriate, for display 120.

The conditional access network 140 can include a wide variety of components, including routers, switches, radio frequency converters, splitters, and repeaters, optical wavelength transmitters, repeaters, and receivers, analog modems, satellite uplinks/downlinks, etc. However these components are arranged, the effect is to allow the subscriber a (not necessarily broadband) channel for communicating with the service operator, and to provide at least one broadband channel for delivery of video and other broadband services to the subscriber.

Uplink receiver 150 and downlink transmitter 152 are typically located at the edge of conditional access network 140. At uplink receiver 150, content requests from the exemplary media viewing system 110 will typically arrive multiplexed with traffic from other subscribers. Likewise, at downlink transmitter 152 content for multiple subscribers may be mixed. Note that uplink receiver 150 and downlink transmitter 152 may exist, e.g., on interface cards resident in content server 160, or on one or more switches/routers connected directly or through a network to content server 160.

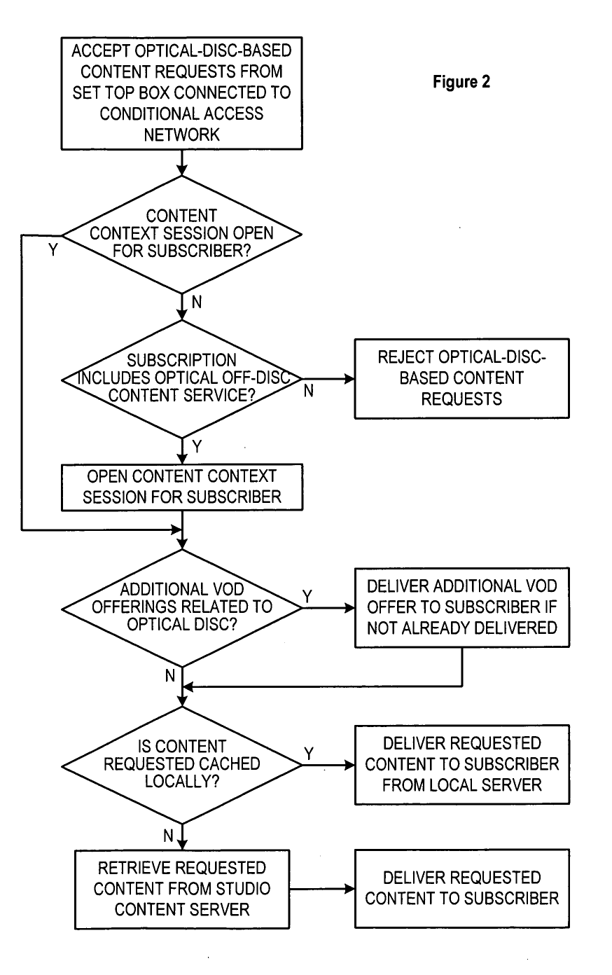

FIG. 2 contains a flowchart illustrating operation of content server 160 in one exemplary mode. Content server 160 accepts properly formatted DVD off-disc content requests from media viewing system 110. With each content request, the server attempts to match the request with a subscriber content context session. When no session exists, the content server verifies that the subscriber's subscription includes the optical off-disc content delivery service—if the service is not included in the subscription, optical-disc-based content requests for the subscriber are rejected (e.g., by returning an error message to the subscriber and offering them the opportunity to subscribe if the service is available in their viewing area). Subscription information may be located on the server, or stored on a separate subscriber database server (not shown).

Assuming that the subscriber has access to the service but no context session was found, the content server opens a context session for the subscriber and optical disc currently being viewed by that subscriber. The context session can track what off-disc content the subscriber has already accessed during the session and include other subscriber preferences or equipment capabilities, e.g., from a database.

For specific DVDs being viewed by the subscriber, the content server may be provisioned with suggested content offerings that will be delivered to the subscriber at least the first time the service is accessed for a given session. This suggested content can include trailers for upcoming movies, trailers for movies currently available from the operator's video-on-demand library and likely to appeal to viewers of the specific DVD, or lists of such trailers or available movies. The trailers can be stored on the content server, or accessible through video on demand server 170 (FIG. 1). Note that trailers or videos ordered by the subscriber may either be supplied through the content server, or the video on demand server 170 can respond to instructions from content server 160 to supply the content directly to the conditional access network.

Assuming that the viewer has already viewed the additional offerings (or has skipped through the presentation), the content server determines whether the requested content is cached locally. For popular and newly-released DVDs, the content server may experience frequent requests for off-disc content related to those DVDs. To reduce traffic on packet network 180 and latency, content server 160 can choose to locally cache frequently accessed and/or significantly sized off-disc content. The local caching of studio content may require that permission be obtained from the content owner. In at least some embodiments, the content server would not cache content for which permission has not been obtained. When requested content is locally cached, content server 160 delivers a copy of the locally cached content to the subscriber. Otherwise, the content server interprets the “native Internet” request encapsulated in the content request, retrieves the resources, e.g., from a studio content server 190 (FIG. 1), and delivers the requested content to the subscriber.

Note that the requested content may itself refer to other content, i.e., a web page may include references to imbedded content. The content server can anticipate the need for the imbedded content from the web page and download the imbedded content early, or wait for the media viewing system to specifically request each item of content.

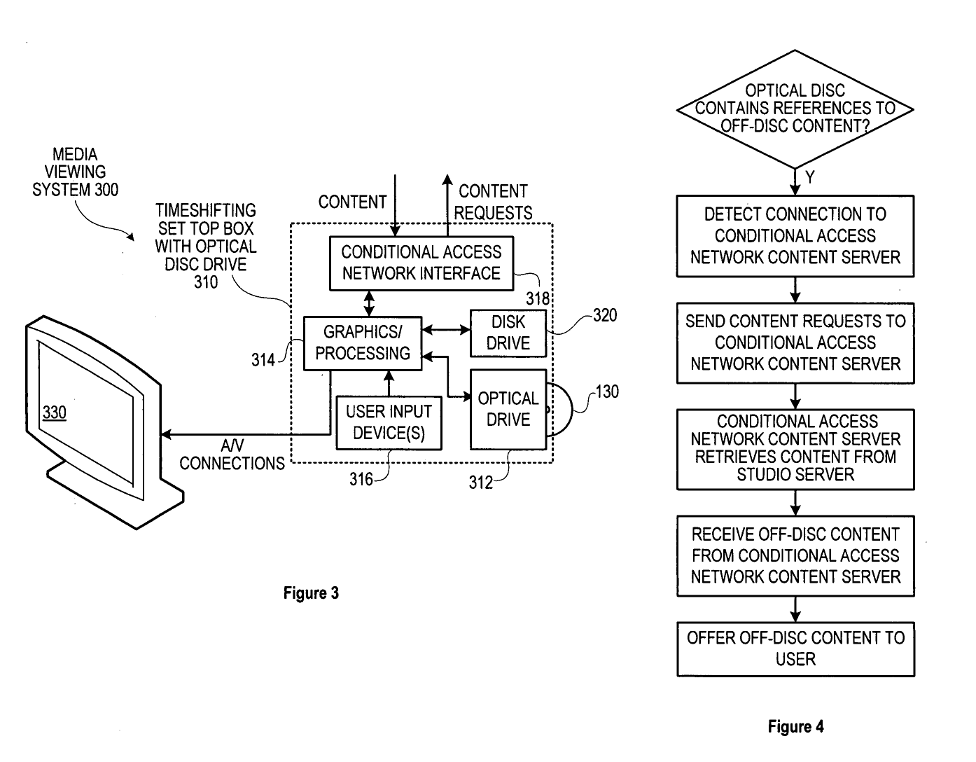

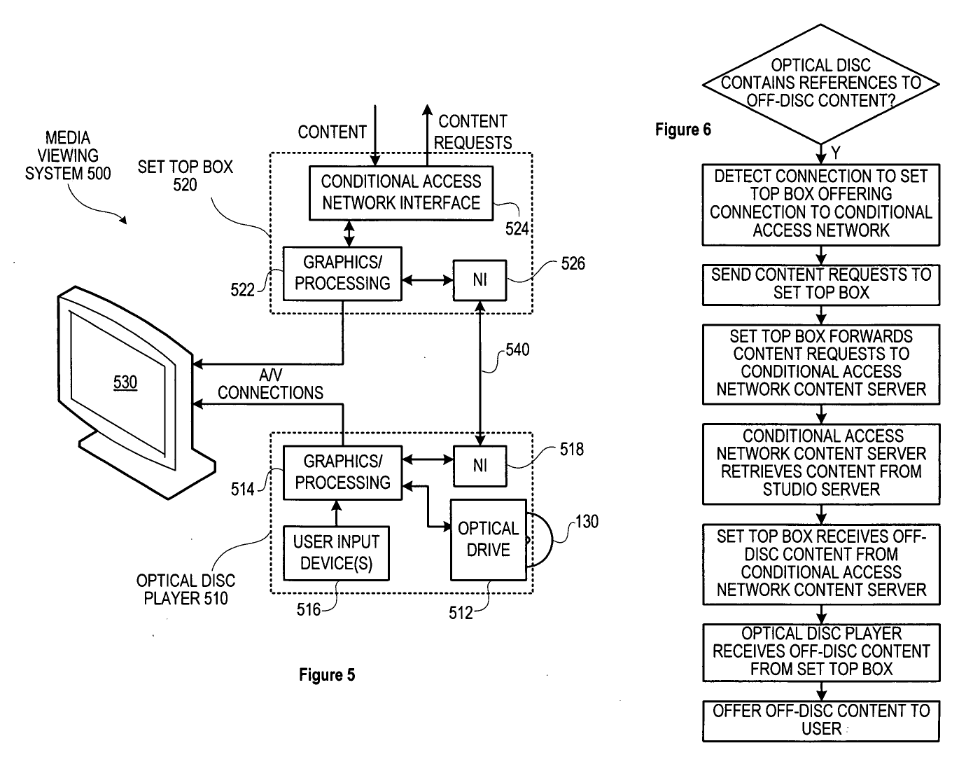

The IHS or systems that make up a media viewing system including an embodiment can take various form factors. The media viewing system 110 presented in FIG. 1 is generic to a variety of form factors, including personal computers, set top boxes with integrated or separate DVD players, and other digital media viewing systems. FIGS. 3 and 5 present further details on two representative form factors.

FIG. 3 depicts a media viewing system 300 including a timeshifting set top box with an integrated optical disc drive 310. Set top box 310 includes an optical drive 312, graphics/processing 314, user input devices 316, and a conditional access network interface 318.

Set top box 310 operates in at least three different modes. In the first mode, set top box 310 operates as a traditional timeshifting cable receiver, i.e., it allows the viewer to view/pause/record/replay one or more “live” broadcasts offered in their subscription package. In this mode, graphics/processing 314 selects the appropriate digital channel(s) for reception by conditional access network interface 318, records the content downlinked on those channels onto disk drive 320, and plays the content as requested by decoding the content onto audio/video connections to a video receiver 330. The user input devices 316 typically include front-panel buttons and an infrared (IR) port that receives signals from a user remote. The user input devices allow the viewer to control operation of the set top box as a timeshifting receiver.

In the second mode, set top box 310 operates as a traditional DVD player, i.e., it allows the viewer to view/pause/navigate/fast forward/rewind the content stored on a DVD 130 inserted in optical drive 312. In this mode, graphics/processing 314 controls optical drive 130 according to user inputs from user input devices 316, receives the DVD content from optical drive 312, and plays the content as requested by decoding the content onto the audio/video connections.

In the third mode, set top box 310 retrieves and plays off-DVD content from a CATV operator's content server. FIG. 4 contains a flowchart illustrating steps in one operational embodiment according to this third mode.

Graphics/processing 314 first determines that an optical disc 130 contains one or more references to off-disc content. This step can be performed, e.g., by scanning the menu content when the disc is first inserted in optical drive 312, by scanning the content of a particular menu when that menu is called up by a viewer, or by waiting for the viewer to actually select a reference to content that is located off-disc. The earlier the determination is made, the earlier the content can be requested, and the more seamless the viewing experience can appear. Of course, if the viewer never actually requests the off-disc content, any downloading done prior to an actual viewer request may be wasted effort.

Referring to the next step in FIG. 4, set top box 310 detects a connection to a content server reachable through the conditional access network. The presence of the content server service can be verified, e.g., during system power-up, periodically while set top box 310 is operating, when an optical disc in inserted, when off-disc content is actually needed, or any combination of these events. For instance, the network operator's protocols can include hello message exchanges that allow a set top box to determine the presence (and possible the address) of a designated content server. Graphics/processing 314 initiates such a message exchange by submitting a message to conditional access network interface 318 and waiting for a return message to be received from the interface. Assuming that no content server is detected, graphics/processing 314 may notify the viewer that the requested content is currently unavailable when off-disc content is requested.

Assuming that a connection to the content server is available, graphics/processing 314 formats the DVD off-disc content requests for submission to the conditional access network. As described above, this can include, for instance, encapsulating the off-disc content requests in one or more packets addressed to the CATV operator's content server, flagged as DVD off-disc content requests, identifying the DVD, and including a reference to the requested off-disc content. The conditional access network interface 318 accepts the encapsulated requests and forwards them onto the conditional access network uplink using the mechanism already in place for forwarding other set top box uplinked information.

The CATV operator locates the off-disc content as previously described and provides the content on a downlink channel to the conditional access network interface 318. The set top box receives the content, which is then handled in one of several ways by graphics/processing 314. First, if the off-disc content represents something that the user has requested for immediate viewing, graphics/processing 314 creates a viewable representation of the content, e.g., a navigable web page or menu, streaming video and/or audio, an interactive game, etc. In particular if the content includes streaming video or audio, that content may be downloaded at a high rate and buffered onto disk drive 320 during playback.

The user can also request the off-disc content for later viewing, in which case the received content is cached onto the disk drive 320. A visual indication, such as an icon, can be displayed to the viewer when the download is ready for viewing.

As mentioned previously, off-disc content can also be requested and downloaded with no user request, for possible viewing. For instance, even when the disc has no explicit reference to off-disc content, the DVD identification information can be used by graphics/processing 314 to query a content server for off-disc content such as movie trailers, video-on-demand offerings, websites, licensed products, etc., related to the movie. Again, an icon, menu entry, etc., can be used to indicate to the viewer that the set top box has found off-disc content of interest.

From the foregoing description, it is apparent that the first, second, and third modes are not mutually exclusive. For instance, the viewer can watch the DVD on-disc content while recording a cable channel and/or downloading off-disc content related to the DVD. Depending on the requirements of the CATV system operator, each item of the off-disc content can be deleted from the set top box as it is viewed, persist for a limited time or as long as the optical disc remains in the system, or be savable by the viewer for longer periods of time. The content owner can establish permissions for the content that restrict the manner in which the viewer is able to store/replay the content.

FIG. 5 depicts a media viewing system 500 including an optical disc player 510, a set top box 520, and a video monitor 530. Both the optical disc player and the set top box couple to the video monitor via audio/video connections. Additionally, the set top box and the optical disc player communicate with each other across a communication link 540, as will be further described below.

Optical disc player 510 contains an optical drive 512, graphics/processing 514, one or more user input devices 516, and a network interface 518. Optical drive 512, graphics/processing 514, and user input devices 516 cooperate in traditional fashion to allow a viewer to navigate and view on-disc content when a DVD 130 in inserted in optical drive 512.

Network interface 518 couples to graphics/processing 514 to provide a capability for optical disc player 510 to access off-disc content. Network interface 518 can provide an interface to a communication port with, e.g., one of many standard forms, such as an Ethernet port, an IEEE 1394 (Firewire) port, a Universal Serial Bus (USB) port, optical port, or a wireless port. In at least some of these forms, network interface 518 can allow optical disc player 510 to connect to a Local Area Network (LAN) with broadband connectivity to the Internet. In the present embodiment, however, network interface 518 is used to form a communication link with a peer network interface 526 located in set top box 520.

Set top box 520 contains graphics/processing 522, a conditional access network interface 524, and the network interface 526 (preferably of the same type as network interface 518; otherwise some sort of converter between the two would be required). Graphics/processing 522 and conditional access network interface 524 cooperate to allow set top box 520 to operate as a traditional set top box for viewing cable channels.

Network interface 526 allows set top box 520 to communicate with optical disc player 510, when the two are coupled via a communication link 540 (cable, optical fiber, or wireless). Set top box 520 can therefore cooperate with optical disc player 510 to deliver off-disc content to a viewer, for instance, using the method depicted in the flowchart of FIG. 6.

Graphics/processing 514 first determines that an optical disc 130 contains one or more references to off-disc content. This step can be performed, e.g., by scanning the menu content when the disc is first inserted in optical drive 512, by scanning the content of a particular menu when that menu is called up by a viewer, or by waiting for the viewer to actually select a reference to content that is located off-disc. The earlier the determination is made, the earlier the content can be requested, and the more seamless the viewing experience can appear. Of course, if the viewer never actually requests the off-disc content, any downloading done prior to an actual viewer request may be wasted effort.

Referring to the next step in FIG. 6, optical disc player 510 detects a network connection to a set top box offering connection to a content server reachable through the conditional access network. At least two operational models are possible. In one mode, the optical disc player recognizes that a conditional access network interface will be used, and cooperates in formatting content requests for the conditional access network. In this mode, the presence of the content server service can be verified, e.g., during system power-up, periodically while optical disc player 510 and set top box 520 are operating, when an optical disc in inserted, when off-disc content is actually needed, or any combination of these events. For instance, the network operator's protocols can include hello message exchanges that allow a set top box and/or optical disc player to determine the presence (and possible the address) of a designated content server. Graphics/processing 514 initiates such a message exchange by submitting a message to network interface 518 for forwarding through network interface 526 and graphics/processing 522 to conditional access network interface 524, and waiting for a return message to be received from the interface. Assuming that no content server is detected, graphics/processing 514 may notify the viewer that the requested content is currently unavailable when off-disc content is requested.

In another possible operational mode, optical disc player 510 is unaware that communication link 540 does not connect player 510 to the Internet. Optical disc player 510 issues content requests just as it would when connected to the Internet. In this mode, the content requests arrive at the set top box 520, and the set top box encapsulates packets from optical disc player 510 in a format that can be passed across the conditional access network to the cable operator's content server. As described above, this can include, for instance, encapsulating the off-disc content requests in one or more packets addressed to the CATV operator's content server, with the packets flagged as DVD off-disc content requests, identifying the DVD, and including a reference to the requested off-disc content. The conditional access network interface 524 accepts the encapsulated requests and forwards them onto the conditional access network uplink using the mechanism already in place for forwarding other set top box uplinked information.

The content server de-encapsulates the received packets and serves the requested content back to the set top box, either from a local cache, or by obtaining the content from the server requested by the optical disc player, as described above. Note that in this operational mode, the set top box (and the content server) may not be able to obtain an explicit identification of the DVD from which the content request was derived, if the optical disc player is not set to provide this information. The DVD identification could be implied, however, from known off-disc content references, and the set top box may be able to verify that it is connected to an optical disc player.

The set top box receives the off-disc content, removes any encapsulation particular to the conditional access network, and forwards the content to the optical disc player 510. Depending on the memory capacity of the optical disc player, the player may or may not be able to store much off-disc content. If it can store content, however, content could be requested and downloaded in advance.

Another potential difference from the previous embodiment is that the optical disc player may not be able to accept content that it did not request, i.e., additional offerings from the CATV operator and keyed to the optical disc. These offerings could still be downloaded to the set top box, however, should the viewer wish to check for content related to the DVD that they have recently viewed.

A variety of IHSs have been described above. For purposes of this disclosure, an IHS may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, the IHS may be a personal computer, including notebook computers, personal digital assistants, cellular phones, gaming consoles, a network storage device, a set top box, an optical disc player, or any other suitable device and may vary in size, shape, performance, functionality, and price. The IHS may include random access memory (RAM), one or more processing resources such as central processing unit (CPU) or hardware or software control logic, ROM, and/or other types of nonvolatile memory. Additional components of the IHS may include one or more disk drives, one or more network ports for communicating with external devices as well as various input and output (I/O) devices, such as a keyboard, a mouse, and a video display. The IHS may also include one or more buses operable to receive/transmit communications between the various hardware components.

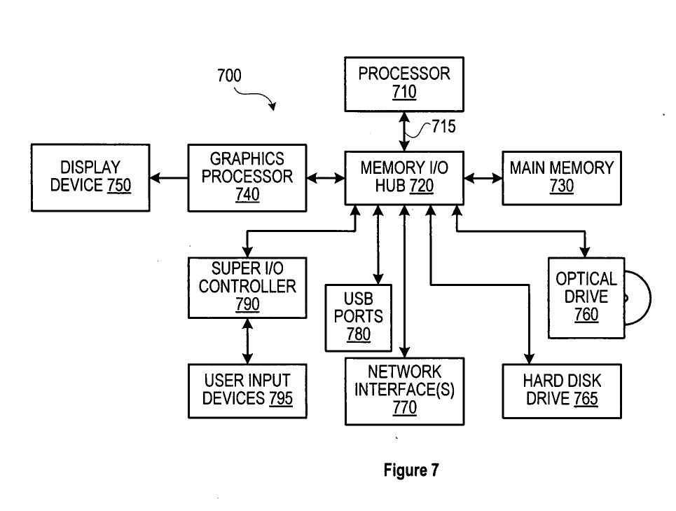

FIG. 7 illustrates a block diagram of an IHS 700, according to an embodiment. In a particular embodiment, the IHS 700 is used to implement at least one component of the system 100 described with reference to FIG. 1, e.g., a component of the media viewing system 110 such as a set top box or a DVD player or a combination unit or computer media viewing system, or the content server 160. The IHS 700 includes a processor 710 coupled by a processor bus 715 to a memory I/O hub 720. Memory I/O hub coordinates operations between processor 710 and system main memory 730, implemented using dynamic random access memory (DRAM), with at least some boot code located on non-volatile memory. A graphics processor 740 also connects to memory I/O hub 720, and performs graphics functions necessary to generate graphics signals for a display device 750. Memory I/O hub also serves as an attachment point for an optical drive 760 and a hard disk drive 765 (if used—a hard disk drive in some systems may be replaced with non-volatile memory, such as flash memory). One or more network interfaces 770 also connect via a bus to memory I/O hub 720. In some systems, one of these network interfaces will be a conditional access network interface. In many systems, Universal Serial Bus ports 780 are also supported through memory I/O hub 720. Finally, a super I/O controller 790 receives signals from one or more user input devices 795, such as a keyboard, keypad, or dedicated function buttons, a pointing device such as a mouse, an infrared or radio frequency remote control, etc.

The processor 710 and graphics processor 740 are operable to execute the computing instructions and/or operations of the IHS 700. Main memory 730, as well as hard disk drive 765, preferably store instructions (also known as a “software program”) for implementing various embodiments of a method in accordance with the present disclosure. In various embodiments the instructions and/or software programs may be implemented in various ways and using different coding languages.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A method for delivering media content to a user, the method comprising:
based on content read from optical media, initiating a request to a conditional access network interface for content not stored on the optical media;
receiving, from the conditional access network interface, content supplied in response to the request; and
generating graphical display signals for a user display based on the content supplied in response to the request.

2. The method of claim 1, wherein the request identifies the optical media to gain access to a conditional access network through the conditional access network interface.

3. The method of claim 1, wherein content supplied in response to the request comprises one or more items selected from the group of content types consisting of digital video, digital images, software, scripts, markup language files, interactive menus, and combinations thereof.

4. The method of claim 1, wherein the conditional access network interface is co-located in a device that generates the graphical display signals based on the content supplied in response to the request.

5. The method of claim 1, further comprising storing the content supplied in response to the request on a writeable digital media, after receipt from the conditional access network interface.

6. The method of claim 5, wherein, while other content is viewed by the user, the content supplied in response to the request is temporarily stored on the writeable digital media for later display to the user.

7. The method of claim 1, further comprising generating a graphical menu based on the content read from the optical media, and initiating the request in response to a user selection from the graphical menu.

8. The method of claim 1, wherein the conditional access network interface is co-located in the same device that reads the optical media.

9. A system to provide media content comprising:
a conditional access system downlink driver to provide content to a subscriber connected to a conditional access network;
a conditional access system uplink receiver to receive content requests from the subscriber connected to the conditional access network; and
a content request server to respond to content requests received at the conditional access system uplink receiver, wherein the content request server responds to a first content request received from the subscriber and based on content read from optical media by directing the supply of content responsive to the content request to the conditional access system downlink driver.

10. The system of claim 9, wherein directing the supply of content responsive to the content request comprises requesting the content from a third party server based on a network resource locator supplied with the first content request.

11. The system of claim 10, wherein the content responsive to the content request is retrieved prior to receiving the content request, and cached local to the content request server for retrieval in response to the content request.

12. The system of claim 9, wherein directing the supply of content responsive to the content request comprises identifying the optical media that generated the first content request.

13. The system of claim 12, wherein directing the supply of content responsive to the content request further comprises identifying content offered by the system operator to users of the identified optical media.

14. The system of claim 13, wherein directing the supply of content responsive to the content request further comprises generating interactive data for offering the identified content to the subscriber.

15. The system of claim 13, wherein the identified content comprises video on demand.

16. An information handling system (IHS) comprising:
a processor group, comprising at least one processor, to translate an expanded content request generated based on content read from optical media into a request to a conditional access network content server; and
a conditional access network interface to transmit the request to the conditional access network content server and to receive the expanded content back from the server.

17. The IHS of claim 16, further comprising an optical drive to read optical media.

18. The IHS of claim 16, further comprising a hard disk drive to store the expanded content received back from the server.

19. The IHS of claim 16, further comprising a port to receive the expanded content requests from a separate device having an optical drive to read optical media.

20. The IHS of claim 19, further comprising a driver that, when executed by the processor group, encapsulates the expanded content requests received from the separate device in a format compatible with a conditional access network, and addresses the encapsulated content requests to a content server attached to the conditional access network.
